(19) United States
(12) Patent Application Publication
(10) Pub. No.: US 2019/0337486 A1
(43) Pub. Date: Nov. 7, 2019

(54) VEHICLE WIPER DEVICE

(71) Applicant: DENSO CORPORATION, Kariya-shi, Aichi-ken (JP)

(72) Inventor: Norihiro SUGIMOTO, Kariya-shi (JP)

(73) Assignee: DENSO CORPORATION, Kariya-shi, Aichi-ken (JP)

(21) Appl. No.: 16/343,996

(22) PCT Filed: Oct. 18, 2017
(86) PCT No.: PCT/JP2017/037728

§ 371 Date: Apr. 22, 2019

(30) Foreign Application Priority Data
Dec. 9, 2016 (JP) 2016-239204
Dec. 14, 2016 (JP) 2016-242194

(51) Int. Cl. B60S 1/08; B60S 1/18; B60S 1/28; B60S 1/36

(52) U.S. Cl. CPC B60S 1/08; B60S 1/36; B60S 1/28; B60S 1/18

(57) ABSTRACT

A vehicle wiper device includes a first driving lever, a second driving lever, a first driven lever, a second driven lever, a first wiper arm, a first wiper blade, a second wiper arm, and a second wiper blade. The first driving lever is pivoted by a driving force of a first drive source. The second driving lever is pivoted by a driving force of a second drive source. A pivoting speed of the second wiper blade from a lower reversal position is set to be greater than a pivoting speed of the first wiper blade from a lower reversal position.

### TECHNICAL FIELD

The present invention relates to a vehicle wiper device.

### BACKGROUND ART

A vehicle wiper device installed on a vehicle such as an automobile may rotate a wiper arm and a wiper blade about a single point serving as the axis. In addition, a vehicle wiper device may include a four-bar link mechanism so that the wipe range of a front window (wiped surface) differs from a simple sectoral range and is set to a desired range (substantially enlarged range) (for example, refer to patent document 1).

Such a vehicle wiper device includes a main lever (driving lever) pivotally supported by the vehicle body at the lower end (ground side) of the front window. When the main lever is reciprocally pivoted by driving force of a drive source, the driving force of the main lever (driving lever) drives and pivots other levers including an arm head. Thus, the front window is wiped at a portion close to an upper corner beyond the simple sectoral range.

### PRIOR ART DOCUMENT

### Patent Document

Patent Document 1: Japanese Laid-Open Patent Publication No. 11-227572

### SUMMARY OF THE INVENTION

### Problems that are to be Solved by the Invention

However, in a vehicle wiper device using a four-bar link mechanism such as that described above, the wipe range that can be enlarged by each lever is uniquely set. Thus, the wipe range cannot be varied.

It is an object of the present invention to provide a vehicle wiper device capable of varying the wipe range in a favorable manner.

### Means for Solving the Problem

To achieve the above object, a vehicle wiper device includes a first driving lever, a second driving lever, a first driven lever, a second driven lever, a first wiper arm, a first wiper blade, a second wiper arm, and a second wiper blade. The first driving lever has a proximal end that is pivotal about a first axis located at a fixed position in relation to a vehicle body. The first driving lever is pivoted by a driving force of a first drive source. The second driving lever has a proximal end that is pivotal about a second axis located at a fixed position in relation to the vehicle body. The second driving lever is pivoted by a driving force of a second drive source. The first driven lever has a proximal end connected to the first driving lever and pivotal about a third axis. The third axis is located at a distal side of the first driving lever. The second driven lever has a proximal end and a distal end. The proximal end is connected to the first driven lever and pivotal about a fourth axis, which is located at a distal side of the first driven lever. The distal end is connected to the second driving lever and pivotal about a fifth axis, which is located at a distal side of the second driving lever. The first wiper arm is provided so as to operate integrally with the second driven lever. The first wiper blade is connected to a distal end of the first wiper arm and reciprocally wipes a wiped surface between upper and lower reversal positions. The second wiper blade is connected to a distal end of the second wiper arm and reciprocally wipes the wiped surface between upper and lower reversal positions. A pivoting speed of the second wiper blade from the lower reversal position is set to be greater than a pivoting speed of the first wiper blade from the lower reversal position.

### BRIEF DESCRIPTION OF THE DRAWINGS

FIG. 1 is a partial schematic diagram of a vehicle including a vehicle wiper device according to a first embodiment.

FIG. 2 is a plan view of the vehicle wiper device of FIG. 1.

FIG. 3 is a cross-sectional view taken along line 2A-2A in FIG. 2.

FIG. 4 is a plan view illustrating an operation of the vehicle wiper device of FIG. 2.

FIG. 5 is a plan view illustrating an operation of the vehicle wiper device of FIG. 2.

FIG. 6 is a plan view illustrating an operation of the vehicle wiper device of FIG. 2.

FIG. 7 is a plan view illustrating an operation of the vehicle wiper device of FIG. 2.

FIG. 8 is a characteristic diagram between time and mechanism speed reduction ratio in the vehicle wiper device of FIG. 2.

FIG. 9 is a partial schematic diagram of a vehicle including a vehicle wiper device according to another example.

FIG. 10 is a partial schematic diagram of a vehicle including a vehicle wiper device according to a second embodiment.

FIG. 11 is a plan view of the vehicle wiper device of FIG. 10.

FIG. 12 is a cross-sectional view taken along line 11A-11A of FIG. 11.

FIG. 13 is a plan view illustrating an operation of the vehicle wiper device of FIG. 11.

FIG. 14 is a plan view illustrating an operation of the vehicle wiper device of FIG. 11.

FIG. 15 is a plan view illustrating an operation of the vehicle wiper device of FIG. 11.

FIG. 16 is a plan view illustrating an operation of the vehicle wiper device of FIG. 11.

FIG. 17 is a schematic diagram showing an angular range of pivoting of the first and second motors of FIG. 11.

### EMBODIMENTS OF THE INVENTION

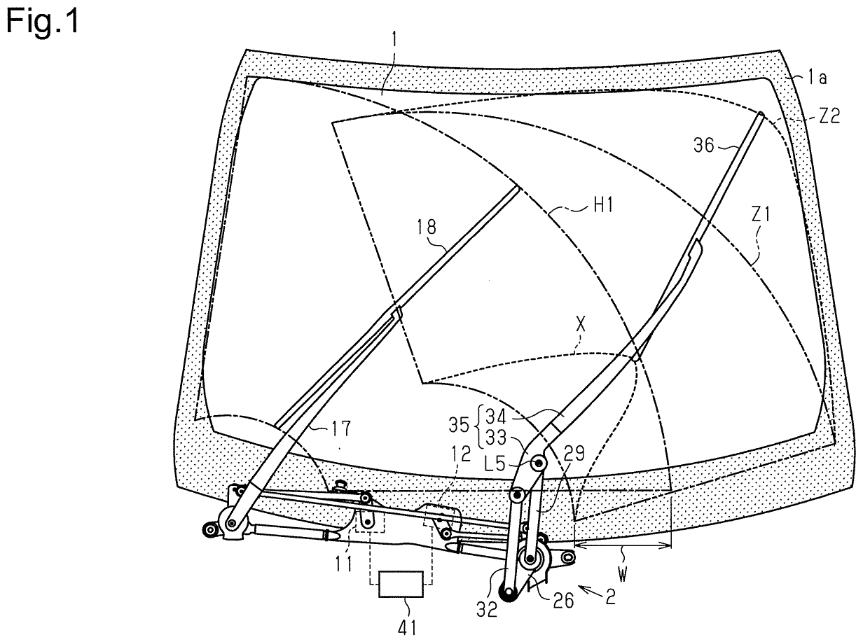

Hereinafter, a first embodiment of a vehicle including a vehicle wiper device will be described with reference to FIGS. 1 to 8.

As shown in FIG. 1, a vehicle wiper device 2 is disposed at a lower side (toward ground) of a front window 1, which corresponds to a wiped surface of a vehicle. The front window 1 has an edge that is colored black defining a black ceramic area 1a (shaded portion in FIG. 1).

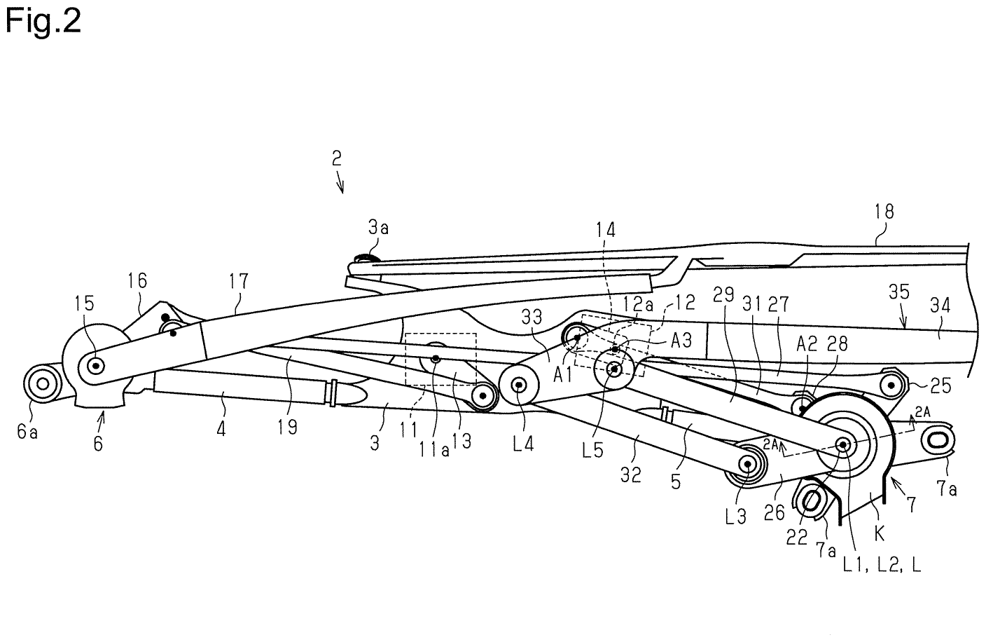

As shown in FIGS. 2 and 4 to 7, the vehicle wiper device 2 includes a plate-shaped central frame 3, two pipe frames 4 and 5 extending from the central frame 3 to opposite sides in the vehicle width direction and having one end fixed to the central frame 3, and first and second holder members 6 and 7 fixed to the other ends of the respective pipe frames 4 and 5. The central frame 3 includes a support portion 3a supported by the vehicle, and the first and second holder members 6 and 7 include fixing portions 6a and 7a fastened to the vehicle. Thus, the vehicle wiper device 2 is fixed to the vehicle (vehicle body).

The vehicle wiper device 2 further includes a first motor 11 corresponding to a first drive source and a second motor 12 corresponding to a second drive source, which are fixed to a rear surface (surface located toward the inner side of the vehicle) of the central frame 3.

The first motor 11 includes a rotation shaft 11a extending through the central frame 3 and projecting from a surface (surface toward the outer side of the vehicle) of the central frame 3. A first driving crank arm 13 is fixed to the distal end of the rotation shaft 11a. The second motor 12 includes a rotation shaft 12a extending through the central frame 3 and projecting from a surface (surface toward the outer side of the vehicle) of the central frame 3. A second driving crank arm 14 is fixed to the distal end of the rotation shaft 12a. The second motor 12 is a motor (brushed DC motor or brushless motor) that is controlled so that the rotation shaft 12a rotates forward and reversely at a pivot angle (predetermined pivot angle in the present embodiment) that is less than one revolution while controlling the rotation speed. Each of the first motor 11 and the second motor 12 has an internal magnetic sensor (e.g., magnetoresistance element). The magnetic sensors, for example, sense the magnetism of a sensor magnet fixed to a worm wheel that rotates integrally with the respective rotation shafts 11a and 12a and output a rotational position signal corresponding to the rotational position (pivot angle) of the rotation shafts 11a and 12a.

The first holder member 6 rotatably supports a driver seat side pivot shaft 15. The driver seat side pivot shaft 15 has a proximal end (end located behind the plane of FIG. 2) to which a driver seat side swing lever 16 is fixed. A second wiper arm 17 is located at the driver seat side and (arm head of second wiper arm 17) is fixed to the distal end (end located frontward on the plane of FIG. 2) of the driver seat side pivot shaft 15. As shown in FIG. 1, a second wiper blade 18 for wiping the driver seat side of the front window 1 is connected to the distal end of the second wiper arm 17.

The distal end of the first driving crank arm 13 and the driver seat side swing lever 16 are connected by a first connection rod 19. Thus, when the first motor 11 is driven, the first driving crank arm 13 rotates. The driving power is transmitted via the first connection rod 19 to the driver seat side swing lever 16 to swing the driver seat side swing lever 16. The second wiper arm 17 swings together with the driver seat side swing lever 16. As a result, the second wiper blade 18 reciprocally wipes the driver seat side of the front window 1 in a range between the upper reversal position and the lower reversal position. In FIG. 1, the single-dashed line indicates a normal wipe range H1 of the second wiper blade 18.

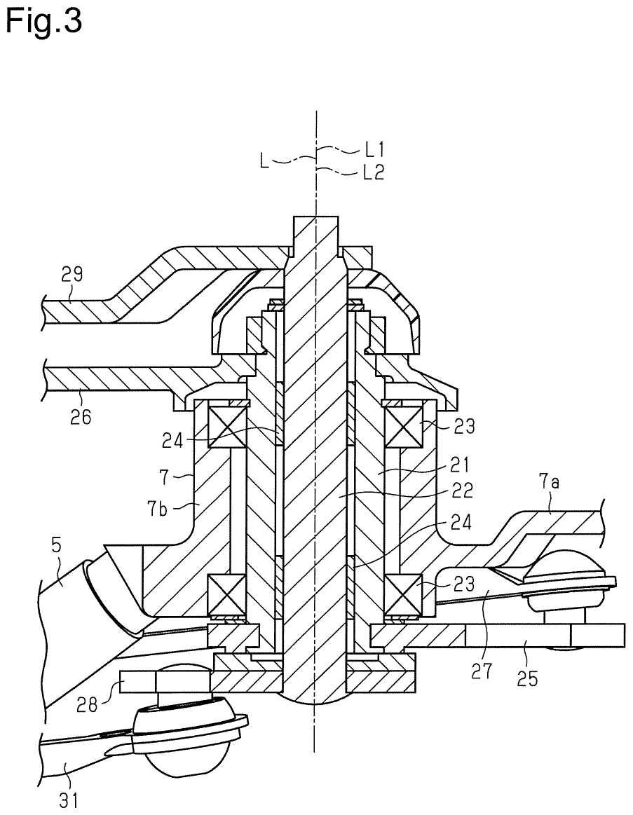

As shown in FIG. 3, the second holder member 7 pivotally supports a passenger seat side first pivot shaft 21 about a first axis L1 and a passenger seat side second pivot shaft 22 about a second axis L2. In the present embodiment, the first axis L1 and the second axis L2 are disposed on the same straight line L (concentrically).

More specifically, the second holder member 7 includes a tubular portion 7b, and the passenger seat side first pivot shaft 21 is pivotally supported by bearings 23 at an inner circumferential side of the tubular portion 7b. The passenger seat side first pivot shaft 21 is tubular, and the passenger seat side second pivot shaft 22 is pivotally supported by bearings 24 at an inner circumferential side of the passenger seat side first pivot shaft 21. Thus, the first axis L1 of the passenger seat side first pivot shaft 21 and the second axis L2 of the passenger seat side second pivot shaft 22 are located at a fixed position (immovable position) in relation to the vehicle body and are disposed on the same straight line L.

The passenger seat side first pivot shaft 21 has a proximal end, to which a passenger seat side first swing lever 25 is fixed, and a distal end, to which a first driving lever 26 is fixed. As shown in FIG. 2, the passenger seat side first swing lever 25 and the driver seat side swing lever 16 are connected and driven by a second connection rod 27. Thus, when the first motor 11 is driven and the driver seat side swing lever 16 swings as described above, the driving force is transmitted via the second connection rod 27 to the passenger seat side first swing lever 25 to swing the passenger seat side first swing lever 25. The first driving lever 26 swings (pivots) about the first axis L1 together with the passenger seat side first swing lever 25.

As shown in FIG. 3, the passenger seat side second pivot shaft 22 is longer than the passenger seat side first pivot shaft 21. The proximal end and the distal end of the passenger seat side second pivot shaft 22 project from the passenger seat side first pivot shaft 21 in the axial direction. A passenger seat side second swing lever 28 is fixed to the proximal end, and a second driving lever 29 is fixed to the distal end of the passenger seat side second pivot shaft 22.

The distal end of the second driving crank arm 14 and the passenger seat side second swing lever 28 are connected by a third connection rod 31. Thus, when the second motor 12 is driven, the second driving crank arm 14 pivots so that the driving power is transmitted via the third connection rod 31 to the passenger seat side second swing lever 28 to swing the passenger seat side second swing lever 28. The second driving lever 29 swings (pivots) together with the passenger seat side second swing lever 28. The passenger seat side first pivot shaft 21 and the passenger seat side second pivot shaft 22 are not interlocked with each other. In other words, although the passenger seat side first pivot shaft 21 and the passenger seat side second pivot shaft 22 are disposed on the same straight line L, the pivoting operations are independent from each other. In FIGS. 2 and 4 to 7, a water protection cover K is shown on the second holder member 7. However, the water protection cover K is not shown in FIG. 3.

As shown in FIGS. 2 and 4 to 7, the vehicle wiper device 2 includes a first driven lever 32 having a proximal end that is connected to the first driving lever 26 and pivotal about a third axis L3 located at the distal side of the first driving lever 26.

The vehicle wiper device 2 includes an arm head 33 corresponding to a second driven lever. The arm head 33 has a proximal end that is connected to the first driven lever 32 and pivotal about a fourth axis L4, which is located at the distal side of the first driven lever 32, and a distal end that is connected to the second driving lever 29 and pivotal about a fifth axis L5, which is located at the distal side of the second driving lever 29 (swing center axis). As shown in FIG. 1, the arm head 33 is configured to be a first wiper arm 35 together with, for example, a retainer 34 connected to the distal end of the arm head 33 and an arm piece, which is not shown in the drawings. A first wiper blade 36 for wiping the passenger seat side of the front window 1 is connected to the distal end of the first wiper arm 35.

The first driving lever 26, the second driving lever 29, the first driven lever 32, and the arm head 33 are set and connected so that the length from the first axis L1 (the second axis L2) to the third axis L3 is equal to the length from the fourth axis L4 to the fifth axis L5. Additionally, the first driving lever 26, the second driving lever 29, the first driven lever 32, and the arm head 33 are set and connected so that the length from the third axis L3 to the fourth axis L4 is equal to the length of the first axis L1 (the second axis L2) to the fifth axis L5. That is, the first driving lever 26, the second driving lever 29, the first driven lever 32, and the arm head 33 are configured to be a parallelogram link mechanism in which the first driving lever 26 and the arm head 33 maintain parallelism and the second driving lever 29 and the first driven lever 32 maintain parallelism. In the present embodiment, the first driving lever 26, the first driven lever 32, and the arm head 33 are configured to be a swing mechanism and a swing link mechanism that are driven by the driving force of the first motor 11 to reciprocally swing the first wiper arm 35. In the present embodiment, the second driving lever 29 is configured to be an extension-contraction mechanism that is driven by the driving force of the second motor 12 to extend and contract the first wiper arm 35 in the longitudinal direction. Further, the second driving lever 29 is configured to be an axis moving mechanism that moves the swing center axis (the fifth axis L5) of the first wiper arm 35 in the vertical direction of the front window 1.

With the above configuration, when driving force of the first motor 11 pivots the first driving lever 26 and the first wiper blade 36 performs an wiping operation, driving force of the second motor 12 pivots the second driving lever 29 so that the fifth axis L5, which is located at the distal side of the second driving lever 29, moves to the upper side of the front window 1. Thus, the vehicle wiper device 2 is capable of enlarging (varying) the wipe range of the first wiper blade 36.

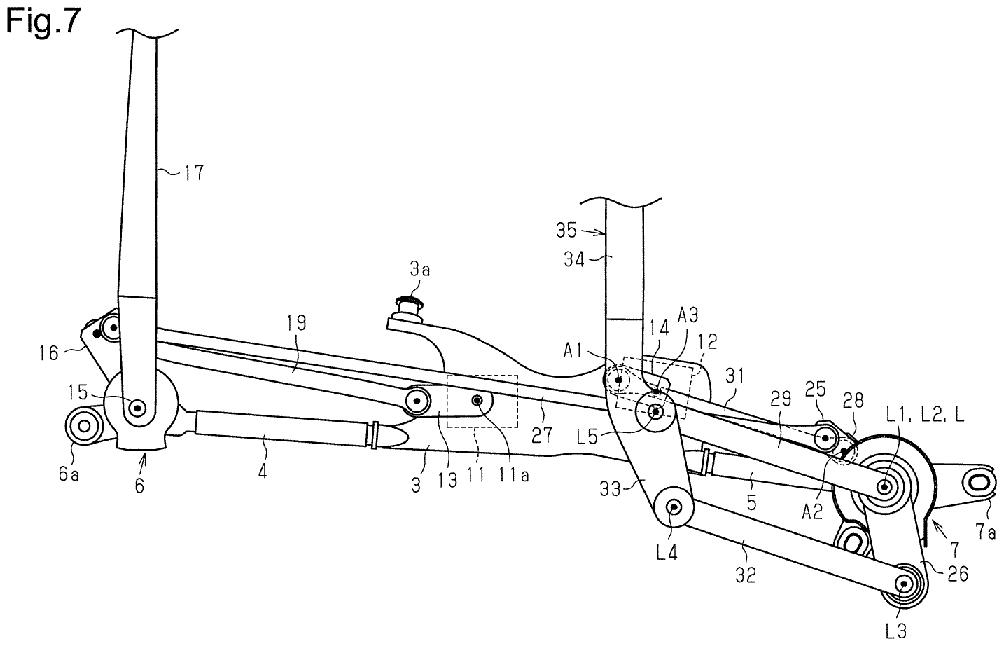

As shown in FIG. 1, the vehicle wiper device 2 of the present embodiment includes a control unit 41 that drives and controls the first motor 11 and the second motor 12 to switch between a reference driving in which the wipe range of the first wiper blade 36 is set to a reference range Z1, and an enlargement driving in which the wipe range of the first wiper blade 36 is set to an enlarged range Z2 that is greater than the reference range Z1. The reference range Z1 is a wipe range of the first wiper blade 36 when the fifth axis L5 is located in a reference position. The reference position refers to the position of the fifth axis L5 when the first wiper blade 36 is located in the lower reversal position on the front window 1. The enlarged range Z2 is a wipe range of the first wiper blade 36 when the fifth axis L5 is moved from the reference position toward the upper side of the front window 1. The control unit 41 is electrically connected to the first motor 11 and the second motor 12 to drive and control the first motor 11 and the second motor 12 on the basis of rotational position signals (driving state signals) corresponding to the rotational positions (pivot angles) of the rotation shafts 11a and 12a received from the first motor 11 and the second motor 12. More specifically, the reference position is set to the position of the fifth axis L5 when the first wiper blade is located in the lower reversal position. In the reference driving, the control unit 41 drives and controls the first motor 11 (at this time, the second motor 12 is stopped) so that the reference range Z1 is wiped by the first wiper blade 36 with the fifth axis L5 located in the reference position (position shown in FIGS. 2 and 7). In other words, in the reference driving, the control unit 41 causes the first wiper blade 36 to wipe the reference range Z1 while keeping the fifth axis L5 in the reference position (by driving only the swing mechanism (swing link mechanism)) without swinging (pivoting) the second driving lever 29 about the second axis L2 (without driving the extension-contraction mechanism (axis moving mechanism)). On the other hand, in the enlargement driving, the control unit 41 drives and controls the first motor 11 and the second motor 12 (drives the extension-contraction mechanism (axis moving mechanism) and the swing mechanism (swing link mechanism)) to cause the first wiper blade 36 to wipe the enlarged range Z2, which is enlarged from the reference range Z1, by moving (or while moving) the fifth axis L5, which is located at the distal side of the second driving lever 29, from the reference position toward the upper side of the front window 1 (refer to FIGS. 1 and 4 to 6).

In normal operation, the control unit 41 of the present embodiment drives and controls the second motor 12 so that the enlargement driving is performed when the first wiper blade 36 moves forward (moves from the rest position along the lower end of the front window 1 or the lower reversal position to the upper reversal position) and moves backward (moves from the upper reversal position to the rest position or the lower reversal position). In the enlargement driving, while moving (pivoting) the first wiper blade 36 by rotating the first driving lever 26 with the driving force of the first motor 11, the control unit 41 simultaneously drives and controls the second motor 12 so that the first wiper blade 36 wipes the front window 1 to a position close to the upper corner. That is, when moving the first wiper blade 36 to a position corresponding to the upper corner of the front window 1, the control unit 41 drives and controls the second motor 12 so that the fifth axis L5, which is located at the distal side of the second driving lever 29 and is the pivot center of the first wiper blade 36, moves closer to the corner based on the rotational position signals received from the first motor 11 and the second motor 12.

The second motor 12 and the second driving lever 29 are connected via a link mechanism (the second driving crank arm 14, the third connection rod 31, and the passenger seat side second swing lever 28) that is set to serve as dead center at which the rotation shaft 12a of the second motor 12 cannot rotate even when a rotational force is applied to the second driving lever 29 with the fifth axis L5 located in the reference position. More specifically, when the fifth axis L5 is located in the reference position (refer to FIGS. 2 and 7), the second driving crank arm 14, the third connection rod 31, and the passenger seat side second swing lever 28 are set so that the connecting axes A1 and A2 and the axis A3 of the rotation shaft 12a of the second motor 12 form a straight line as viewed in the axial direction. This allows the fifth axis L5 to be mechanically held in the reference position, for example, without generating a holding torque with the second motor 12. Thus, for example, when the second motor 12 fails, the fifth axis L5 will be held in the reference position. The reference driving is performed even when the enlargement driving cannot be performed.

The vehicle wiper device 2 of the present embodiment is set so that when the first motor 11 is driven, the first driving lever 26 swings (pivots) within a range of the lower part of the front window 1 relative to the first axis L1, that is, does not swing (pivot) above the first axis L1.

In the present embodiment, when the second wiper blade 18, which is located at the driver seat side, is located in the lower reversal position (rest position), the distal side of the second wiper blade 18 is disposed above the first wiper blade 36 in a direction along the surface of the front window 1. In other words, in the lower reversal position (rest position), the distal end of the second wiper blade 18 and the proximal end of the first wiper blade 36 are set to have a lap range W vertically overlapping each other in the direction along the surface of the front window 1. The length and the lap range W of the second wiper blade 18 are set so that the second wiper blade 18 has a wipe range H1 that includes the entire movement path X of the proximal end of the first wiper blade 36 (however, the portion of the movement path below the lower reversal position (rest position) of the second wiper blade 18 is excluded). Thus, the wipe range (i.e., the enlarged range Z2) of the first wiper blade 36 does not include an unwiped range.

The pivoting speed of the second wiper blade 18 from the lower reversal position (rest position) is set to be greater than the pivoting speed (moving speed) of the first wiper blade 36.

More specifically, different mechanism speed reduction ratios are set for a first drive connection mechanism that connects and drives the first motor 11 and the first driving lever 26 and a second drive connection mechanism that connects and drives the first motor 11 and the second wiper arm 17. Thus, in the present embodiment, the pivoting speed of the second wiper blade 18 from the lower reversal position is greater than the pivoting speed of the first wiper blade 36. In the present embodiment, the first drive connection mechanism is a link mechanism including the first driving crank arm 13, the first connection rod 19, the driver seat side swing lever 16, the second connection rod 27, and the passenger seat side first swing lever 25. The second drive connection mechanism is a link mechanism that includes the first driving crank arm 13, the first connection rod 19, and the driver seat side swing lever 16. The mechanism speed reduction ratio of the first drive connection mechanism is a value obtained by dividing the rotation speed of the first motor 11 by the rotation speed of the first driving lever 26 (can be read as the moving speed of the first wiper blade 36). The mechanism speed reduction ratio of the second drive connection mechanism is a value obtained by dividing the rotation speed of the first motor 11 by the rotation speed of the second wiper arm 17 (can be read as the moving speed of the second wiper blade 18). The mechanism speed reduction ratio of the first drive connection mechanism from the lower reversal position is set to be greater than the mechanism speed reduction ratio of the second drive connection mechanism so that the pivoting speed of the second wiper blade 18 from the lower reversal position is greater than the pivoting speed of the first wiper blade 36, that is, the first wiper blade 36 is set so as not to catch up with the second wiper blade 18.

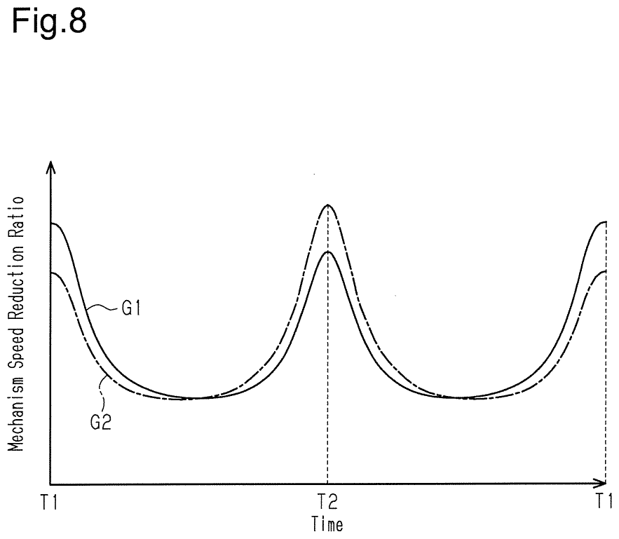

More specifically, as shown in FIG. 8, a mechanism speed reduction ratio G1 of the first drive connection mechanism and a mechanism speed reduction ratio G2 of the second drive connection mechanism according to the present embodiment are set so that the mechanism speed reduction ratio G1 of the first drive connection mechanism is greater than the mechanism speed reduction ratio G2 of the second drive connection mechanism from the lower reversal position (time T1 in FIG. 8) (at a position in the vicinity of the lower reversal position including the lower reversal position). Additionally, the mechanism speed reduction ratios G1 and G2 are equal to each other at a position approximately equidistant and between the upper and lower reversal positions. The mechanism speed reduction ratio G2 of the second drive connection mechanism is greater than the mechanism speed reduction ratio G1 of the first drive connection mechanism at a position in the vicinity of the upper reversal position including the upper reversal position (time T2 in FIG. 8). FIG. 8 shows the mechanism speed reduction ratios G1 and G2 when the vehicle wiper device 2 reciprocates once. The first and second wiper blades 36 and 18 are located in the lower reversal position at time T1 and in the upper reversal position at time T2.

Next, the operation of the vehicle wiper device 2 configured as described above will be described.

When the first motor 11 is driven, the second wiper arm 17 and the second wiper blade 18 simply pivot (swing) about the driver seat side pivot shaft 15 serving as the axis center. Thus, movement of the first wiper arm 35 and the first wiper blade 36 will be described in detail.

For example, as shown in FIG. 2, when the first wiper arm 35 (and the first wiper blade 36) is located at the rest position and the washer switch provided at the driver seat is operated, the control unit 41 drives the first motor 11 to pivot the first driving lever 26 with the driving force. At this time, the control unit 41 also drives the second motor 12 so that the enlargement operation is performed.

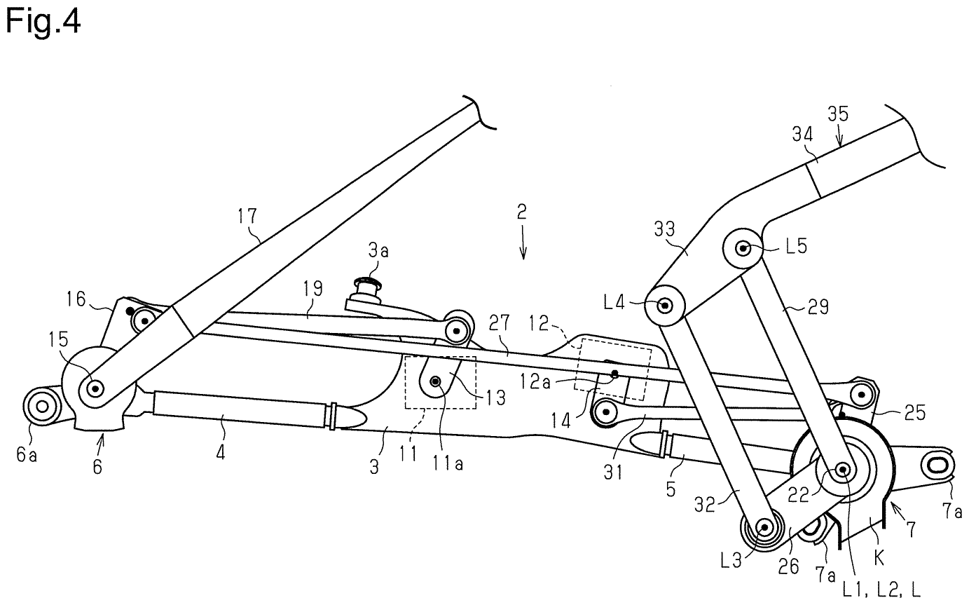

At this time, as shown in FIG. 4, before the pivoting of the first driving lever 26 moves the first wiper arm 35 (and the first wiper blade 36) forward about one-fourth of the distance between the upper and lower reversal positions, the second driving lever 29 is also pivoted to move the fifth axis L5 to the upper side of the front window 1. As a result, the distal end of the first wiper blade 36 (refer to FIG. 1) is moved upward substantially along an end of the front window 1 in the width direction, and the front window 1 is wiped.

At this time, as described above, the pivoting speed of the second wiper blade 18 from the lower reversal position (rest position) is set to be greater than the pivoting speed (moving speed) of the first wiper blade 36. This prevents the first wiper blade 36 from catching up and coming into contact with the second wiper blade 18.

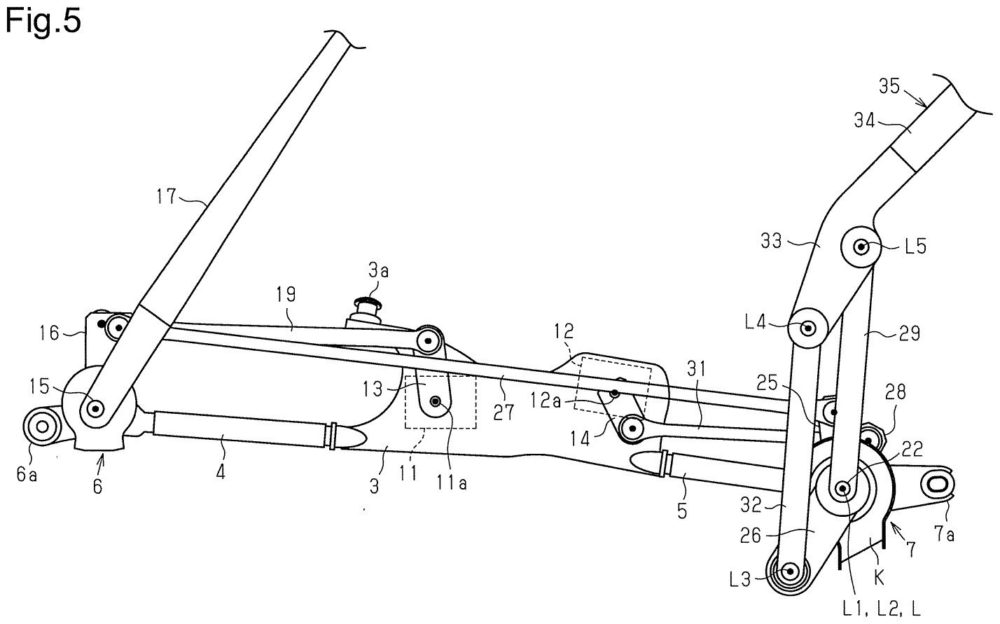

Then, as shown in FIG. 5, before the first driving lever 26 is further pivoted and the first wiper arm 35 (and the first wiper blade 36) is moved forward approximately one-half of the distance between the upper and lower reversal positions, the second driving lever 29 is also pivoted so that the fifth axis L5 is further moved upward. As a result, as shown in FIG. 1, the distal end of the first wiper blade 36 is moved to a position close to the upper corner of the front window 1, and the front window 1 is wiped.

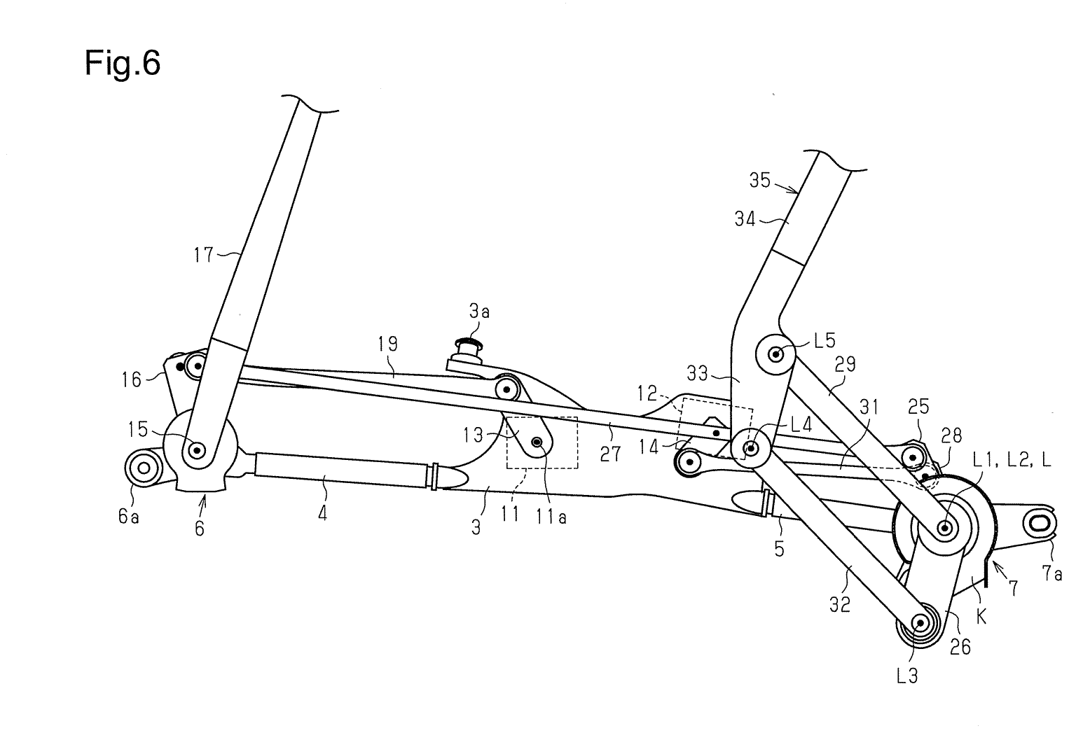

Then, as shown in FIG. 6, until the first driving lever 26 is further pivoted and the first wiper arm 35 (and the first wiper blade 36) is moved forward about three-fourths of the distance between the upper and lower reversal positions, the second driving lever 29 is also pivoted (in the reverse direction) so that the fifth axis L5 is moved toward the lower part of the front window 1. As a result, the distal end of the first wiper blade 36 (refer to FIG. 1) is moved in the width direction (leftward in FIG. 1) substantially along the upper end of the front window 1, and the front window 1 is wiped.

As shown in FIG. 7, until the first driving lever 26 is further pivoted and the forward movement of the first wiper arm 35 (and the first wiper blade 36) is completed, the second driving lever 29 is also pivoted (in the reverse direction) so that the fifth axis L5 is moved to the reference position located further downward. As a result, the enlarged range Z2 of the front window 1 is wiped by the first wiper blade 36 (refer to FIG. 1).

When the backward movement is performed by reverse movement of the above-described forward movement, the enlarged range Z2 is wiped by the first wiper blade 36 (refer to FIG. 1).

The advantageous effects of the above embodiment will be described below.

(1) With the above configuration, when the first driving lever 26 is pivoted by the driving force of the first motor 11 to perform the wiping operation with the first wiper blade 36, the second driving lever 29 is pivoted by the driving force of the second motor 12, which is different from the first motor 11, so that the fifth axis L5, which is located at the distal side of the second driving lever 29, is moved toward the upper side of the front window 1. This satisfactorily enlarges the wipe range of the first wiper blade 36 (obtains the enlarged range Z2). The first wiper blade 36 is capable of wiping the front window 1 to a position close to the upper corner. When the wipe range is enlarged from the lower reversal position as described above, the operation that upwardly moves the fifth axis L5 operates the first wiper blade 36 to be pushed upward. This increases the pivoting speed (moving speed) of the first wiper blade 36. In this regard, in this configuration, the pivoting speed of the second wiper blade 18 from the lower reversal position is intentionally set so as to be greater than the pivoting speed of the first wiper blade 36. This prevents the first wiper blade 36 from catching up and coming into contact with the second wiper blade 18 in the vicinity of the lower reversal position when moving toward the upper reversal position.

(2) The second wiper arm 17 (the second wiper blade 18) is pivoted by the driving force of the first motor 11. Thus, the first motor 11 for rotating the first driving lever 26 is shared. Different mechanism speed reduction ratios are set for the first drive connection mechanism, which connects and drives the first motor 11 and the first driving lever 26, and the second drive connection mechanism, which connects and drives the first motor 11 and the second wiper arm 17, so that the pivoting speed of the second wiper blade 18 from the lower reversal position is set to be greater than the pivoting speed of the first wiper blade 36. Thus, the above-described contact is avoided. That is, the setting of the mechanism speed reduction ratio G1 of the first drive connection mechanism (refer to FIG. 8) and the mechanism speed reduction ratio G2 of the second drive connection mechanism (refer to FIG. 8) allows enlargement of the wipe range of the first wiper blade 36 while sharing the first motor 11. Additionally, the first wiper blade 36 is prevented from catching up and coming into contact with the second wiper blade 18 in the vicinity of the lower reversal position.

(3) When located in the lower reversal position, the second wiper blade 18 is disposed so that part of the second wiper blade 18 is located above the first wiper blade 36 in the direction along the front window 1. When moving toward the upper reversal position, if the first wiper blade 36 catches up with the second wiper blade 18 in the vicinity of the lower reversal position, the first wiper blade 36 would come into contact with the second wiper blade 18. However, according to the configuration of the first embodiment, such contact is avoided.

The first embodiment may be modified as follows.

In the first embodiment, different mechanism speed reduction ratios are set for the first drive connection mechanism and the second drive connection mechanism so that the pivoting speed of the second wiper blade 18 from the lower reversal position is set to be greater than the pivoting speed of the first wiper blade 36. The first drive connection mechanism and the second drive connection mechanism may be changed to other configurations as long as they are set to operate similarly to the first embodiment.

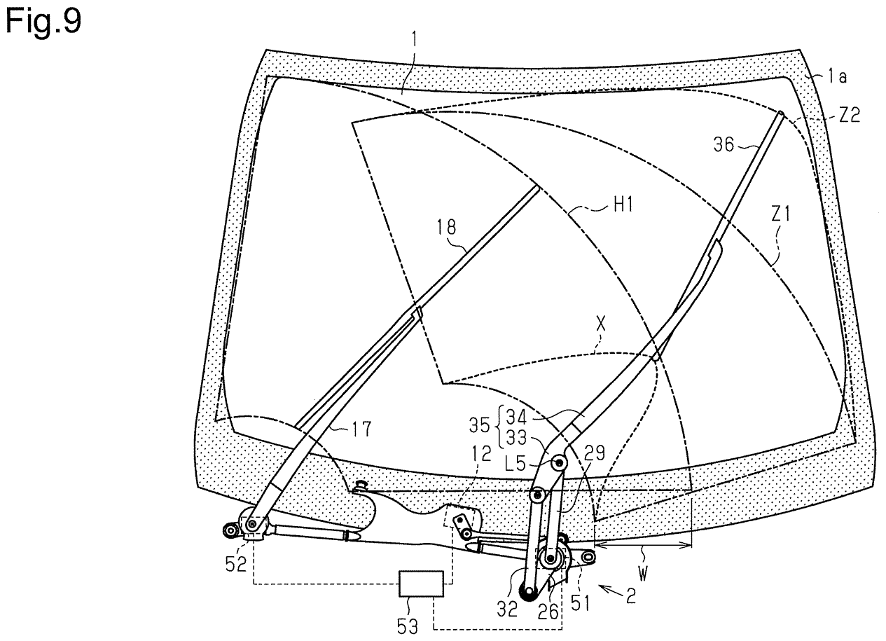

For example, the first drive connection mechanism and the second drive connection mechanism may be changed as shown in FIG. 9. In this example, a first motor 51 that drives the first driving lever 26 is provided immediately below the proximal end of the first driving lever 26, and the rotation shaft of the first motor 51 is directly connected to the passenger seat side first pivot shaft 21 (refer to FIG. 3), which is the axis of the first driving lever 26. The second wiper arm 17 (the second wiper blade 18) is configured to be pivoted by the driving force of a third motor 52 corresponding to a third drive source. The third motor 52 is provided immediately below the proximal end of the second wiper arm 17, and the rotation shaft of the third motor 52 is directly connected to the driver seat side pivot shaft 15, which is the axis of the second wiper arm 17.

The control unit 53 that drives and controls the first motor 51, the second motor 12, and the third motor 52 sets the rotation speed of the first motor 51 to differ from the rotation speed of the third motor 52 so that the pivoting speed of the second wiper blade 18 from the lower reversal position is set to be greater than the pivoting speed of the first wiper blade 36. Even in this case, the first wiper blade 36 is prevented from catching up and coming into contact with the second wiper blade 18 in the vicinity of the lower reversal position. Additionally, the rotation shaft of the first motor 51 is directly connected to the first driving lever 26 (the shaft thereof), and the rotation shaft of the third motor 52 is directly connected to the second wiper arm 17 (the shaft thereof). This eliminates the need for a link mechanism or the like (the first drive connection mechanism and the second drive connection mechanism of the above embodiment).

In the first embodiment, the control unit 41 drives and controls the first motor 11 and the second motor 12 so that the forward and backward movements perform the same enlargement driving in a normal state. However, the present invention is not limited to such a configuration. For example, different controls may be performed in forward movement and backward movement. Additionally, at a time other than the normal state of operation, such as a time when snow accumulates, drive control different from that of the first embodiment (enlargement driving) may be performed.

In the first embodiment, the first axis L1 of the first driving lever 26 and the second axis L2 of the second driving lever 29 are disposed on the same straight line L. However, the present invention is not limited to such a configuration. For example, the first axis L1 of the first driving lever and the second axis L2 of the second driving lever may be disposed at positions different from each other.

The control unit 41 that drives and controls the first motor 11 and the second motor 12 of the first embodiment may be installed as a vehicle-side ECU or may be a control unit installed in at least one of the first motor 11 and the second motor 12, for example, in the second motor 12.

In the first motor 11 and the second motor 12 of the first embodiment, the second motor 12 is controlled to rotate forward and reversely. However, the present invention is not limited such a configuration. The first motor 11 may be a controlled motor that rotates forward and reversely. Both the first motor 11 and the second motor 12 may be controlled motors that rotate forward and reversely. Each of the first motor 11 and the second motor 12 may be a brushed motor or a brushless motor.

In the first embodiment, the second motor 12 and the second driving lever 29 are connected via the link mechanism (the second driving crank arm 14, the third connection rod 31, and the passenger seat side second swing lever 28) that is set to serve as dead center when the fifth axis L5 is located in the reference position. The present invention is not limited to such a configuration. They may be connected without the link mechanism.

In the first embodiment, the first driving lever 26 is pivoted within a range below the first axis L1. However, the first driving lever 26 may be configured to be pivoted in a range above the first axis L1.

In the first embodiment, the length from the first axis L1 to the third axis L3 and the length from the fourth axis L4 to the fifth axis L5 are set to be the same, and the length from the third axis L3 to the fourth axis L4 and the length from the first axis L1 to the fifth axis L5 are set to be the same. However, different lengths may be used.

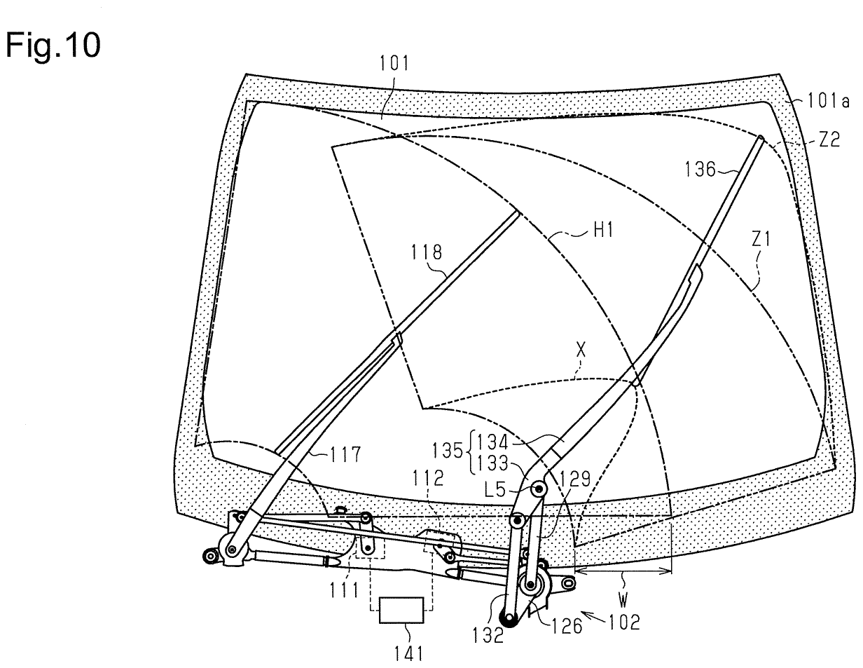

Hereinafter, a second embodiment of a vehicle including a vehicle wiper device will be described with reference to FIGS. 10 to 17.

As shown in FIG. 10, a vehicle wiper device 102 is disposed below a front window 101 (toward ground), which corresponds to a wiped surface of the vehicle. The front window 101 has an edge that is colored black defining a black ceramic area 101a (shaded portion in FIG. 10).

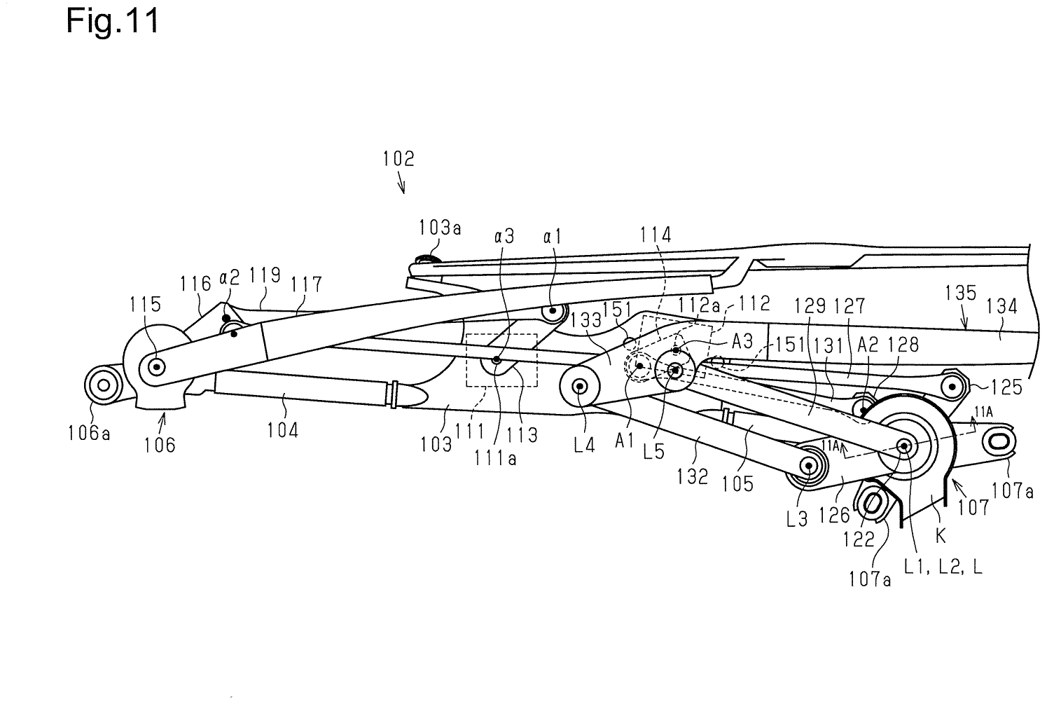

As shown in FIGS. 11 and 13 to 16, the vehicle wiper device 102 includes a plate-shaped central frame 103, two pipe frames 104 and 105 extending from the central frame 103 to opposite sides in the vehicle width direction and having one end fixed to the central frame 103, and first and second holder members 106 and 107 fixed to the other ends of the pipe frames 104 and 105. A support portion 103a provided on the central frame 103 is supported by the vehicle, and fixing portions 106a and 107a formed on the first and second holder members 106 and 107 are fastened to the vehicle. Thus, the vehicle wiper device 102 is fixed to the vehicle (vehicle body).

The vehicle wiper device 102 includes a first motor 111 corresponding to a first drive source and a second motor 112 corresponding to a second drive source, which are fixed to a rear surface (surface located toward the inner side of the vehicle) of the central frame 103.

The first motor 111 includes a rotation shaft 111a extending through the central frame 103 and projecting from a surface (surface toward the outer side of the vehicle) of the central frame 103. A first driving crank arm 113 has a proximal end fixed to the distal end of the rotation shaft 111a. The second motor 112 includes a rotation shaft 112a extending through the central frame 103 and projecting from a surface (surface toward the outer side of the vehicle) of the central frame 103. A second driving crank arm 114 has a proximal end fixed to the distal end of the rotation shaft 112a.

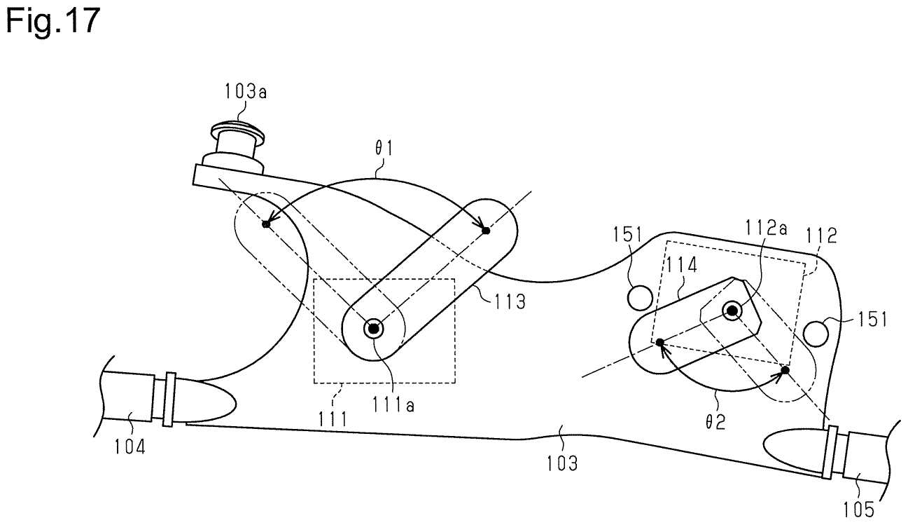

As shown in FIG. 17, the first motor 111 and the second motor 112 are motors (brushed DC motor or brushless motor) that are controlled so that the rotation shafts 111a and 112a are capable of rotating (pivoting) forward and reversely in the angular ranges θ1 and θ2 that are less than one revolution while controlling the rotation speeds. Each of the first motor 111 and the second motor 112 has an internal magnetic sensor (e.g., magnetoresistance element). The magnetic sensors, for example, sense the magnetism of a sensor magnet fixed to a worm wheel that rotates integrally with the respective rotation shafts 111a and 112a and output a rotational position signal corresponding to the rotational position (pivot angle) of the rotation shafts 111a and 112a.

The first holder member 106 rotatably supports a driver seat side pivot shaft 115. The driver seat side pivot shaft 115 has a proximal end (end located behind the plane of FIG. 11) to which a driver seat side swing lever 116 is fixed. The driver seat side pivot shaft 115 has a distal end (end located frontward on the plane of FIG. 11) to which a second wiper arm 117 (its arm head) at the driver seat side is fixed. As shown in FIG. 10, a second wiper blade 118 for wiping the driver seat side of the front window 101 is connected to the distal end of the second wiper arm 117.

The distal end of the first driving crank arm 113 and the driver seat side swing lever 116 are connected by a first connection rod 119. Thus, when the first motor 111 is driven, the first driving crank arm 113 pivots. The driving power is transmitted via the first connection rod 119 to the driver seat side swing lever 116 to swing the driver seat side swing lever 116. The second wiper arm 117 swings (is pivotally driven about a fixed axis relative to the vehicle) together with the driver seat side swing lever 116. As a result, the second wiper blade 118 reciprocally wipes the driver seat side of the front window 101 in the range between the upper reversal position and the lower reversal position. In FIG. 10, the single-dashed line indicates a normal wipe range H1 of the second wiper blade 118.

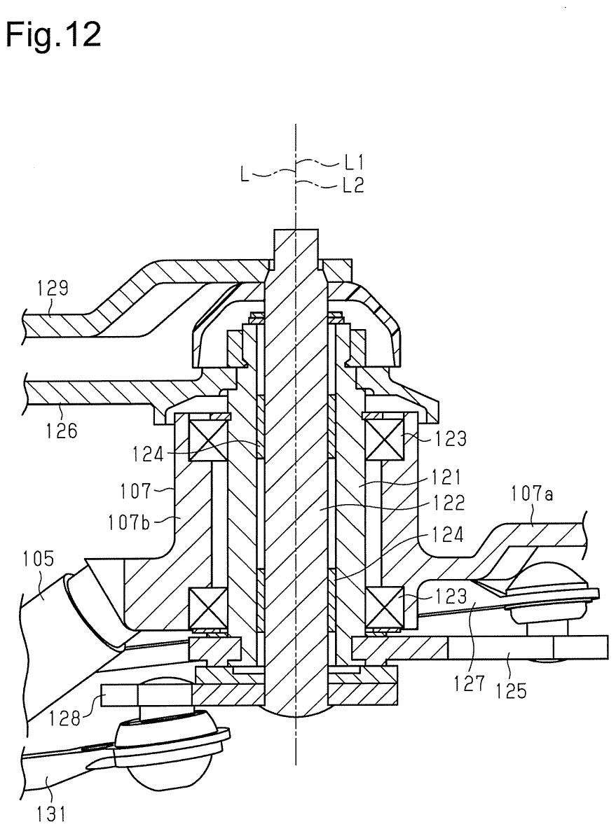

As shown in FIG. 12, the second holder member 107 pivotally supports a passenger seat side first pivot shaft 121 about a first axis L1 and a passenger seat side second pivot shaft 122 about a second axis L2. In the present embodiment, the first axis L1 and the second axis L2 are disposed on the same straight line L (concentrically).

More specifically, the second holder member 107 includes a tubular portion 107b, and the passenger seat side first pivot shaft 121 is pivotally supported by bearings 123 at an inner circumferential side of the tubular portion 107b. The passenger seat side first pivot shaft 121 is tubular, and the passenger seat side second pivot shaft 122 is pivotally supported by bearings 124 at an inner circumferential side of the passenger seat side first pivot shaft 121. Thus, the first axis L1 of the passenger seat side first pivot shaft 121 and the second axis L2 of the passenger seat side second pivot shaft 122 are located at a fixed position (immovable position) in relation to the vehicle body and are disposed on the same straight line L.

The passenger seat side first pivot shaft 121 has a proximal end to which a passenger seat side first swing lever 125 is fixed. The passenger seat side first pivot shaft 121 has a distal end to which a first driving lever 126 is fixed. As shown in FIG. 11, the passenger seat side first swing lever 125 and the driver seat side swing lever 116 are connected and driven by a second connection rod 127. Thus, when the first motor 111 is driven and the driver seat side swing lever 116 swings as described above, the driving force is transmitted via the second connection rod 127 to the passenger seat side first swing lever 125 to swing the passenger seat side first swing lever 125. The first driving lever 126 swings (pivots) about the first axis L1 together with the passenger seat side first swing lever 125.

As shown in FIG. 12, the passenger seat side second pivot shaft 122 is longer than the passenger seat side first pivot shaft 121. The proximal end and the distal end of the passenger seat side second pivot shaft 122 project from the passenger seat side first pivot shaft 121 in the axial direction. A passenger seat side second swing lever 128 is fixed to the proximal end, and a second driving lever 129 is fixed to the distal end of the passenger seat side second pivot shaft 122.

The distal end of the second driving crank arm 114 and the passenger seat side second swing lever 128 are connected by a third connection rod 131. Thus, when the second motor 112 is driven, the second driving crank arm 114 pivots. The driving power is transmitted via the third connection rod 131 to the passenger seat side second swing lever 128 to swing the passenger seat side second swing lever 128. The second driving lever 129 swings (pivots) together with the passenger seat side second swing lever 128. The passenger seat side first pivot shaft 121 and the passenger seat side second pivot shaft 122 are not interlocked with each other. In other words, although the passenger seat side first pivot shaft 121 and the passenger seat side second pivot shaft 122 are disposed on the same straight line L, the pivoting operations are independent from each other. In FIGS. 11 and 13 to 16, a water protection cover K is shown on the second holder member 107. However, the water protection cover K is not shown in FIG. 12.

As shown in FIGS. 11 and 13 to 16, the vehicle wiper device 102 includes a first driven lever 132 having a proximal end pivotally connected about the third axis L3, which is located at the distal side of the first driving lever 126.

The vehicle wiper device 102 further includes an arm head 133 corresponding to a second driven lever. The arm head 133 has a proximal end that is connected to the first driven lever 132 and pivotal about a fourth axis L4, which is located at the distal side of the first driven lever 132, and a distal end that is connected to the second driven lever and pivotal about a fifth axis L5, which is located at the distal side of the second driving lever 129 (swing center axis). As shown in FIG. 10, the arm head 133 is configured to be a first wiper arm 135, for example, together with a retainer 134 connected to the distal end of the arm head 133 and an arm piece, which is not shown in the drawings. A first wiper blade 136 for wiping the passenger seat side of the front window 101 is connected to the distal end of the first wiper arm 135.

The first driving lever 126, the second driving lever 129, the first driven lever 132, and the arm head 133 are set and connected so that the length from the first axis L1 (the second axis L2) to the third axis L3 is the same as the length from the fourth axis L4 to the fifth axis L5. The first driving lever 126, the second driving lever 129, the first driven lever 132, and the arm head 133 are set and connected so that the length from the third axis L3 to the fourth axis L4 is equal to the length of the first axis L1 (the second axis L2) to the fifth axis L5. That is, the first driving lever 126, the second driving lever 129, the first driven lever 132, and the arm head 133 are configured to be a parallelogram link mechanism in which the first driving lever 126 and the arm head 133 maintain parallelism and the second driving lever 129 and the first driven lever 132 maintain parallelism. In the present embodiment, the first driving lever 126, the first driven lever 132, and the arm head 133 are configured to be a swing mechanism that is driven by the driving force of the first motor 111 for reciprocally swinging the first wiper arm 135. In the present embodiment, the second driving lever 129 is configured to be an extension-contraction mechanism that is driven by the driving force of the second motor 112 for extending and contracting the first wiper arm 135 in the longitudinal direction. Additionally, the second driving lever 129 is configured to be an axis moving mechanism that moves the swing center axis (the fifth axis L5) of the first wiper arm 135 in the vertical direction of the front window 101.

With the above configuration, when the driving force of the first motor 111 pivots the first driving lever 126 and the first wiper blade 136 performs a wiping operation, the driving force of the second motor 112 rotates the second driving lever 129 so that the fifth axis L5, which is located at the distal side of the second driving lever 129, moves to the upper side of the front window 101. Thus, the vehicle wiper device 102 is capable of enlarging (varying) the wipe range of the first wiper blade 136.

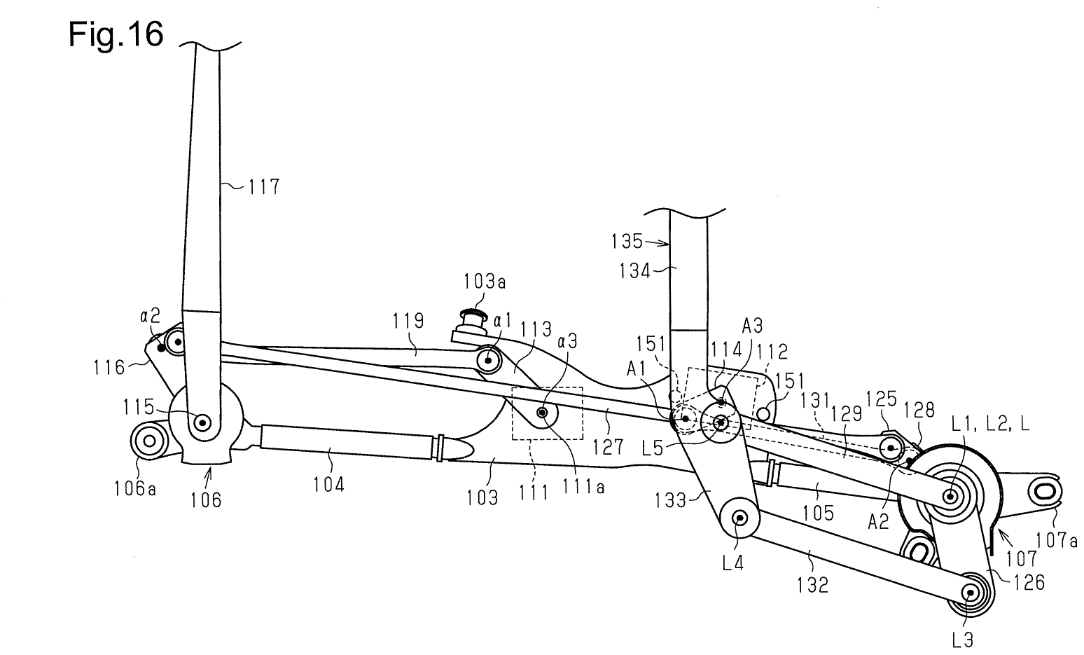

As shown in FIG. 10, the vehicle wiper device 102 of the present embodiment includes a control unit 141 that drives and controls the first motor 111 and the second motor 112 to switch between a reference driving in which the wipe range of the first wiper blade 136 is set to a reference range Z1, and an enlargement driving in which the wipe range of the first wiper blade 136 is set to an enlarged range Z2 that is greater than the reference range Z1. The reference range Z1 is a wipe range of the first wiper blade 136 when the fifth axis L5 is located in a reference position. The reference position refers to a position of the fifth axis L5 when the first wiper blade 136 is located in the lower reversal position on the front window 101. The enlarged range Z2 is a wipe range of the first wiper blade 136 when the fifth axis L5 is moved from the reference position toward the upper side of the front window 101. The control unit 141 is electrically connected to the first motor 111 and the second motor 112 to drive and control the first motor 111 and the second motor 112 on the basis of the rotational position signals (driving state signals) corresponding to the rotational positions (pivot angles) of the rotation shafts 111a and 112a received from the first motor 111 and the second motor 112. More specifically, the reference position is set to the position of the fifth axis L5 when the first wiper blade is located in the lower reversal position. In the reference driving, the control unit 141 drives and controls the first motor 111 (at this time, the second motor 112 is stopped) so that the reference range Z1 is wiped by the first wiper blade 136 with the fifth axis L5 located in the reference position (the position in FIGS. 11 and 16). In other words, in the reference driving, the control unit 141 causes the first wiper blade 136 to wipe the reference range Z1 while keeping the fifth axis L5 in the reference position (by driving only the swing mechanism) without swinging (pivoting) the second driving lever 129 about the second axis L2 (without driving the extension-contraction mechanism (axis moving mechanism)). On the other hand, in the enlargement driving, the control unit 141 drives and controls the first motor 111 and the second motor 112 (drives the extension-contraction mechanism (axis moving mechanism) and the swing mechanism) to cause the first wiper blade 136 to wipe the enlarged range Z2, which is enlarged from the reference range Z1, by moving (or while moving) the fifth axis L5, which is located at the distal side of the second driving lever 129, from the reference position toward the upper side of the front window 101 (refer to FIGS. 10, 13 to 15).

In normal operation, the control unit 141 of the present embodiment drives and controls the second motor 112 so that the enlargement driving is performed when the first wiper blade 136 moves forward (when moving from the rest position or lower reversal position along the lower end of the front window 101 to the upper reversal position) and moves backward (when moving from the upper reversal position to the rest position or the lower reversal position). In the enlargement driving, while moving (pivoting) the first wiper blade 136 by pivoting the first driving lever 126 with the driving force of the first motor 111, the control unit 141 simultaneously drives and controls the second motor 112 so that the first wiper blade 136 wipes the front window 101 to a position close to the upper corner. That is, when moving the first wiper blade 136 to a position corresponding to the upper corner of the front window 101, the control unit 141 drives and controls the second motor 112 so that the fifth axis L5, which is located at the distal side of the second driving lever 129 and is the pivot center of the first wiper blade 136, moves closer to the corner based on the rotational position signals received from the first motor 111 and the second motor 112.

In the present embodiment, the first motor 111 and the second motor 112 are set to be rotated forward and reversely in angular ranges θ1 and θ2 (refer to FIG. 17) that do not include dead center at which the rotation shafts 111a and 112a cannot rotate even when an external force is applied to the first wiper arm 135 and the second wiper arm 117 in each link mechanism described above. In other words, the link mechanisms described above are set so that even when the external force is applied to the first wiper arm 135 and the second wiper arm 117, the first motor 111 and the second motor 112 are rotated forward and reversely in the angular ranges 81 and 82, which do not include dead center at which the rotation shafts 111a and 112a cannot be rotated.

More specifically, the first motor 111 is set to be rotated forward and reversely in the angular range θ1, which does not include dead center at which the rotation shaft 111a cannot be rotated even when an external force is applied to the second wiper arm 117 in a link mechanism including the first driving crank arm 113, the first connection rod 119, and the driver seat side swing lever 116. That is, the first motor 111 is rotated forward and reversely in the angular range θ1 that is less than 180° so that the first driving crank arm 113 and the first connection rod 119 (more specifically, the joints α1 to α3) are not linearly disposed. Similarly, the first motor 111 is set to be rotated forward and reversely in the angular range θ1, which does not include dead center at which the rotation shaft 111a cannot rotate even when an external force is applied to the first wiper arm 135 and the first driving lever 126 in the link mechanism including, for example, the first driving crank arm 113.

The second motor 112 is set to be rotated forward and reversely in the angular range θ2, which does not include dead center at which the rotation shaft 112a cannot rotate even when an external force is applied to the second driving lever 129 in the link mechanism including the second driving crank arm 114, the third connection rod 131, and the passenger seat side second swing lever 128. That is, the second motor 112 is rotated forward and reversely in the angular range θ2 that is less than 180° so that the second driving crank arm 114 and the third connection rod 131 (more specifically, the joints A1 to A3) are not linearly disposed.

As shown in FIG. 17, the central frame 103 includes restriction portions 151 that restrict a movable range of at least part of the link mechanism, in the present embodiment, the second driving crank arm 114. The restriction portions 151 of the present embodiment are two pins provided so as to project from the central frame 103. When the second driving crank arm 114 pivots to an angular range that is slightly greater than the angular range θ2, in which the second driving crank arm 114 is rotated forward and reversely, the restriction portions 151 come into contact with the second driving crank arm 114 to restrict further pivoting.

The vehicle wiper device 102 of the present embodiment is set so that when the first motor 111 is driven, the first driving lever 126 swings (pivots) within the range of the lower part of the front window 101 relative to the first axis L1, in other words, does not swing (pivot) above the first axis L1.

In the present embodiment, when the second wiper blade 118 of the driver seat side is located in the lower reversal position (rest position), the distal side of the second wiper blade 118 is disposed above the first wiper blade 136 in the direction along the surface of the front window 101. In other words, in the lower reversal position (rest position), the distal end of the second wiper blade 118 and the proximal end of the first wiper blade 136 are set to have a lap range W vertically overlapping with each other in the direction along the surface of the front window 101. The length and the lap range W of the second wiper blade 118 are set so that the second wiper blade 118 has a wipe range H1 including the entire movement path X of the proximal end of the first wiper blade 136 (however, the portion of the movement path below the lower reversal position (rest position) of the second wiper blade 118 is excluded). Thus, the wipe range (i.e., the enlarged range Z2) of the first wiper blade 136 does not include an unwiped range.

Next, the operation of the vehicle wiper device 102 configured as described above will be described.

When the first motor 111 is driven, the second wiper arm 117 and the second wiper blade 118 simply pivot (swing) about the driver seat side pivot shaft 115 serving as the axis center. Thus, in this case, movement of the first wiper arm 135 and the first wiper blade 136 will be described in detail.

For example, as shown in FIG. 11, when the first wiper arm 135 (and the first wiper blade 136) is located at the rest position and the washer switch provided at the driver seat is operated, the control unit 141 drives the first motor 111 to pivot the first driving lever 126 with the driving force. At this time, the control unit 141 also drives the second motor 112 so that the enlargement operation is performed.

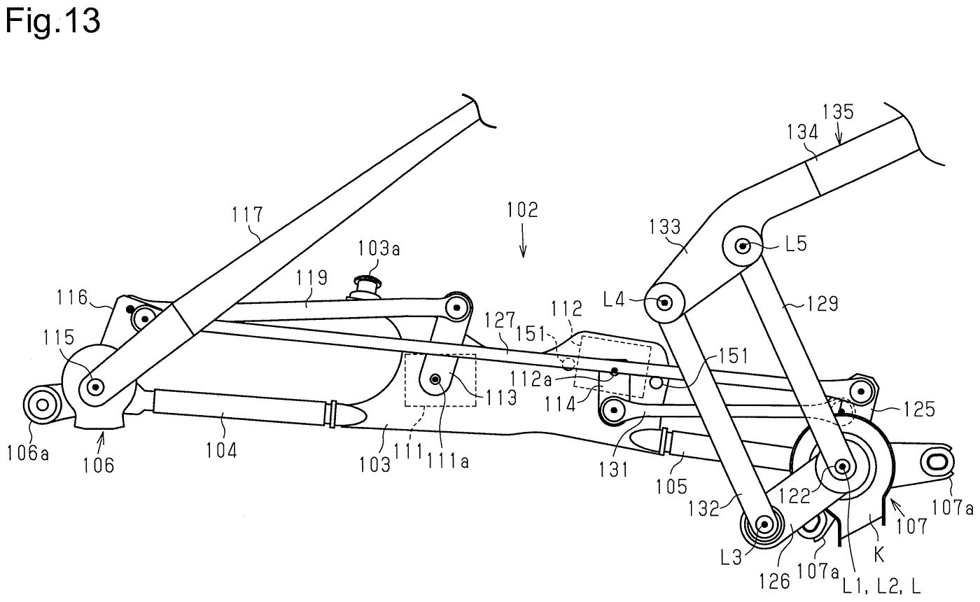

At this time, as shown in FIG. 13, before the pivoting of the first driving lever 126 moves the first wiper arm 135 (and the first wiper blade 136) forward about one-fourth of the distance between the upper and lower reversal positions, the second driving lever 129 is also pivoted so that the fifth axis L5 is moved toward the upper side of the front window 101. As a result, the distal end of the first wiper blade 136 (refer to FIG. 10) is moved upward substantially along the end of the front window 101 in the width direction, and the front window 101 is wiped.

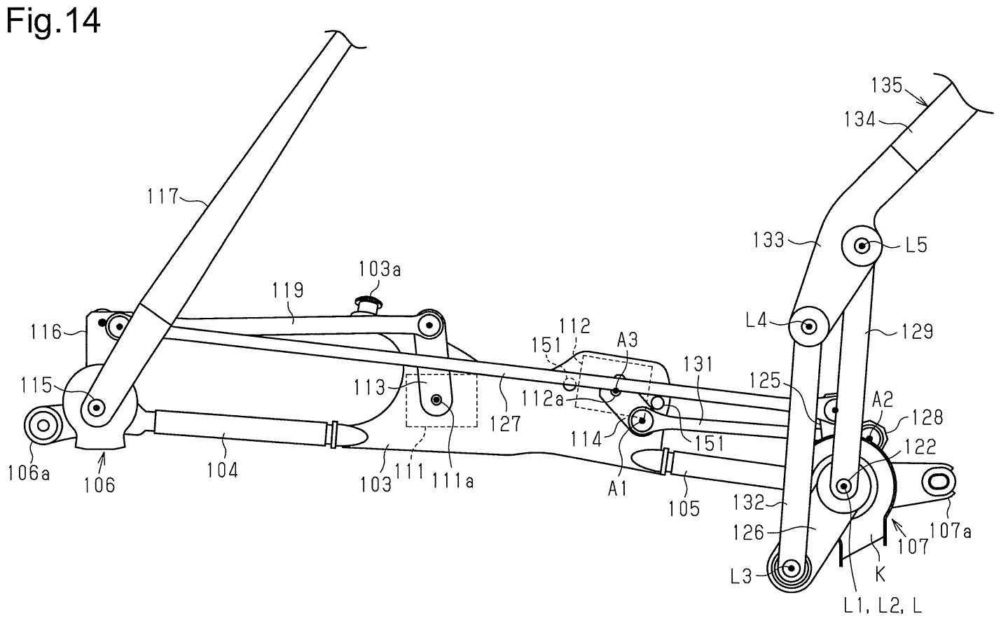

As shown in FIG. 14, before the first driving lever 126 is further pivoted and the first wiper arm 135 (and the first wiper blade 136) is moved forward approximately one-half of the distance between the upper and lower reversal positions, the second driving lever 129 is also pivoted so that the fifth axis L5 is further moved upward. As a result, as shown in FIG. 10, the distal end of the first wiper blade 136 is moved to a position close to the upper corner of the front window 101, and the front window 101 is wiped.

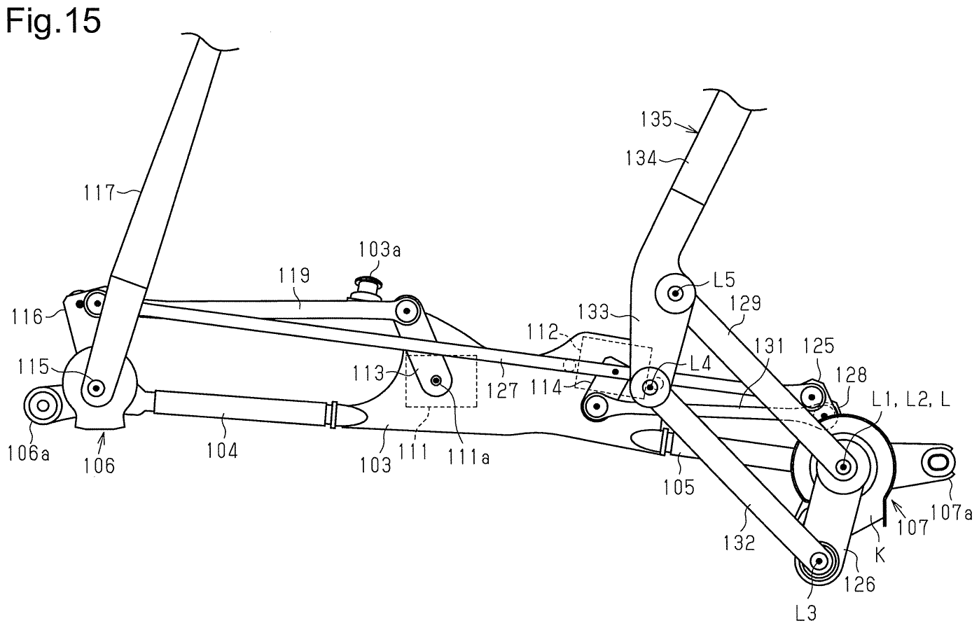

As shown in FIG. 15, until the first driving lever 126 is further pivoted and the first wiper arm 135 (and the first wiper blade 136) is moved forward by about 134 of the distance between the upper and lower reversal positions, the second driving lever 129 is also pivoted (in the reverse direction) so that the fifth axis L5 is moved toward the lower part of the front window 101. As a result, the distal end of the first wiper blade 136 (refer to FIG. 10) is moved in the width direction (leftward in FIG. 10) substantially along the upper end of the front window 101, and the front window 101 is wiped.

As shown in FIG. 16, until the first driving lever 126 is further pivoted and the forward movement of the first wiper arm 135 (and the first wiper blade 136) is completed, the second driving lever 129 is also pivoted (in the reverse direction) so that the fifth axis L5 is moved to the reference position located further downward. As a result, the enlarged range Z2 of the front window 101 is wiped by the first wiper blade 136 (refer to FIG. 10).

When the backward movement is performed by reverse movement of the above-described forward movement, the enlarged range Z2 is wiped by the first wiper blade 136 (refer to FIG. 10).

The advantageous effects of the second embodiment will be described below.

(4) A vehicle wiper device installed on a vehicle such as an automobile may drive a wiper arm via a link mechanism that includes a crank arm having a proximal end fixed to a rotation shaft of a motor capable of forward and reverse rotation (for example, refer to Japanese Laid-Open Patent Publication No. 2015-140041). The vehicle wiper device is set so that when the wiper arm (wiper blade) is located in the lower reversal position, the crank arm and a rod connected to the crank arm are aligned with each other, that is, have dead center at which the rotation shaft cannot be rotated even when an external force is applied to the wiper arm. The motor is configured to be driven from the position of dead center.

However, in the vehicle wiper device described above, when the wiper arm is located in the lower reversal position, the link mechanism is in dead center. Thus, for example, when the wiper arm starts to be driven, the driving speed (pivoting speed) of the wiper arm in the vicinity of reversal positions may be remarkably decreased in relation to the rotation speed of the motor. In this regard, it may be considered that the rotation speed of the motor is increased. However, this results in, for example, enlargement of the motor.

According to the second embodiment, the first motor 111 and the second motor 112 are set to be rotated forward and reversely in the angular ranges θ1 and θ2, which do not include dead center at which the rotation shafts 111a and 112a cannot be rotated even when an external force is applied to the first wiper arm 135 and the second wiper arm 117 in the link mechanisms. Therefore, for example, as compared with a case in which forward and reverse rotations are performed in an angular range that includes dead center, the driving speed of the first and second wiper arms 135 and 117 (the pivoting speed about the driver seat side pivot shaft 115 serving as the axis center, the pivoting speed about the fifth axis L5 serving as the axis center, and the moving speed of the fifth axis L5) is increased in relation to the rotation speed of the first and second motors 111 and 112 even in the vicinity of the reversal positions. Thus, for example, the driving speed of the first and second wiper arms 135 and 117 may be set to an appropriate speed even in the vicinity of the reversal positions while limiting increases in size of the first and second motors 111 and 112.

(5) In the above configuration, when the first driving lever 126 is pivoted by the driving force of the first motor 111 to perform a wiping operation with the first wiper blade 136, the second driving lever 129 is pivoted by the driving force of the second motor 112, which is different from the first motor 111, so that the fifth axis L5, which is located at the distal side of the second driving lever 129, is moved toward the upper side of the front window 101. This satisfactorily enlarges the wipe range of the first wiper blade 136 (obtains the enlarged range Z2). The first wiper blade 136 is capable of wiping the front window 101 to a position close to the upper corner.

The second motor 112 is set to be rotated forward and reversely in the angular range θ2, which does not include dead center at which the rotation shaft 112a cannot be rotated even when an external force is applied to the second driving lever 129 in the link mechanism. Thus, for example, as compared with a case in which forward and reverse rotations are performed in an angular range that includes dead center, the driving speed (moving speed) of the fifth axis L5 is increased in relation to the rotation speed of the second motor 112 even in the vicinity of the reversal positions. That is, the driving speed (moving speed) at which the proximal end of the first wiper arm 135 is moved toward the upper part of the wiped surface is increased even in the vicinity of the reversal positions. Thus, for example, the driving speed at which the proximal end of the first wiper arm 135 is moved toward the upper part of the wiped surface may be set to an appropriate speed even in the vicinity of the reversal position while limiting increases in size of the second motor 112. As a result, the speed of moving the proximal end of the first wiper arm 135 toward the upper part of the wiped surface is satisfactorily (stably) synchronized with the speed at which the first wiper blade 136 performs a wiping operation by pivoting the first driving lever 126 with the driving force of the first motor 111. The wipe range of the first wiper blade 136 is satisfactorily enlarged. In other words, the wipe range of the first wiper blade 136 is satisfactorily enlarged while preventing a decrease in the speed at which the proximal end (the fifth axis L5) of the first wiper arm 135 is moved toward the upper part of the wiped surface in relation to the pivoting speed of the first driving lever 126.

(6) The first motor 111 is set to be rotated forward and reversely in the angular range θ1, which does not include dead center at which the rotation shaft 111a cannot be rotated even when an external force is applied to the first driving lever 126 in the link mechanism. Thus, as compared with a case in which forward and reverse rotations are performed in an angular range that includes dead center, the pivoting speed of the first driving lever 126 is increased in relation to the rotation speed of the first motor 111 even in the vicinity of the reversal positions. Thus, for example, the driving speed of the first wiper arm 135 (the pivoting speed in accordance with the rotation of the first driving lever 126) may be set to an appropriate speed even in the vicinity of the reversal positions while limiting increases in size of the first motor 111.

(7) The first motor 111 is set to be rotated forward and reversely in the angular range θ1, which does not include dead center at which the rotation shaft 111a cannot be rotated even when an external force is applied to the second wiper arm 117. Thus, for example, as compared with a case in which forward and reverse rotations are performed in an angular range that includes dead center, the pivoting speed of the second wiper arm 117 is increased in relation to the rotation speed of the first motor 111 even in the vicinity of the reversal positions. Thus, for example, the pivoting speed of the second wiper arm 117 may be set to an appropriate speed even in the vicinity of the reversal positions while limiting increases in size of the first motor 111.

(8) The restriction portions 151 are provided to restrict the movable range (angular range) of the second driving crank arm 114 in the link mechanism. This restricts a rotation greatly exceeding the angular range θ2, in which the second motor 112 is rotated forward and reversely. Accordingly, for example, even if a malfunction occurs, the rotation greatly exceeding the angular range θ2 is restricted, for example, thereby preventing the wipe range from becoming abnormal (for example, the first wiper blade 136 interferes with an A-pillar of the vehicle).

The second embodiment may be modified as follows.

In the second embodiment, the driving speeds of the first and second wiper arms 135 and 117 (the pivoting speed about the driver seat side pivot shaft 115 serving as the axis center, the pivoting speed about the fifth axis L5 serving as the axis center, and the moving speed of the fifth axis L5) are configured to increase in relation to the rotation speeds of the first and second motors 111 and 112 even in the vicinity of the reversal positions. However, at least one of the driving speeds may be configured to increase.

For example, the first motor 111 may be set to be rotated forward and reversely (or rotated in one direction) in an angular range that includes dead center at which the rotation shaft 111a cannot be rotated even when an external force is applied to the second wiper arm 117 in the link mechanism including the first driving crank arm 113 the first connection rod 119, and the driver seat side swing lever 116. That is, for example, the first driving crank arm 113 and the first connection rod 119 may be set to be aligned with each other in the lower reversal position. This configuration also obtains the same advantage as advantage (5) of the second embodiment.

In the second embodiment, the restriction portions 151 are provided to restrict the movable range (angular range) of the second driving crank arm 114. However, the restriction portions 151 may be another restriction portion as long as the restriction portion restricts a movable range of at least part of the link mechanism. Similarly, the configuration may be such that a restriction portion that restricts the movable range (angular range) of the first driving crank arm 113 is provided or such that another restriction portion that restricts at least part of the movable range of the link mechanism is provided.

In the second embodiment, the control unit 141 drives and controls the first motor 111 and the second motor 112 so that the forward and backward movements perform the same enlargement driving in a normal state. However, the present invention is not limited to such a configuration. For example, different controls may be performed in forward movement and backward movement. Additionally, at a time other than the normal state of operation, such as a time when snow accumulates, drive control different from that of the second embodiment (enlargement driving) may be performed.

In the second embodiment, the first axis L1 of the first driving lever 126 and the second axis L2 of the second driving lever 129 are disposed on the same straight line L. However, the present invention is not limited to such a configuration. For example, the first axis L1 of the first driving lever and the second axis L2 of the second driving lever may be disposed at positions different from each other.

The control unit 141 of the second embodiment that drives and controls the first motor 111 and the second motor 112 may be installed as a vehicle-side ECU or may be a control unit installed in at least one of the first motor 111 and the second motor 112, for example, in the second motor 112.

In the second embodiment, the first driving lever 126 is pivoted within a range below the first axis L1. However, the first driving lever 126 may be configured to be pivoted in a range above the first axis L1.

In the second embodiment, the length from the first axis L1 to the third axis L3 and the length from the fourth axis L4 to the fifth axis L5 are set to be the same, and the length from the third axis L3 to the fourth axis L4 and the length from the first axis L1 to the fifth axis L5 are set to be the same. However, different lengths may be used.

1. A vehicle wiper device, comprising:
a first driving lever having a proximal end that is pivotal about a first axis located at a fixed position in relation to a vehicle body, the first driving lever being pivoted by a driving force of a first drive source;
a second driving lever having a proximal end that is pivotal about a second axis located at a fixed position in relation to the vehicle body, the second driving lever being pivoted by a driving force of a second drive source;
a first driven lever having a proximal end connected to the first driving lever and pivotal about a third axis, the third axis being located at a distal side of the first driving lever;
a second driven lever having a proximal end and a distal end, the proximal end being connected to the first driven lever and pivotal about a fourth axis, the fourth axis being located at a distal side of the first driven lever, the distal end being connected to the second driving lever and pivotal about a fifth axis, and the fifth axis being located at a distal side of the second driving lever;
a first wiper arm provided so as to operate integrally with the second driven lever;
a first wiper blade connected to a distal end of the first wiper arm and reciprocally wiping a wiped surface between upper and lower reversal positions;
a second wiper arm; and
a second wiper blade connected to a distal end of the second wiper arm and reciprocally wiping the wiped surface between upper and lower reversal positions,
wherein a pivoting speed of the second wiper blade from the lower reversal position is set to be greater than a pivoting speed of the first wiper blade from the lower reversal position.

2. The vehicle wiper device according to claim 1, further comprising:
a first drive connection mechanism that connects and drives the first drive source and the first driving lever; and
a second drive connection mechanism that connects and drives the first drive source and the second wiper arm, wherein
the second wiper arm is pivoted by the driving force of the first drive source, and
the pivoting speed of the second wiper blade from the lower reversal position is set to be greater than the pivoting speed of the first wiper blade by setting a mechanism speed reduction ratio of the first drive connection mechanism to differ from a mechanism speed reduction ratio of the second drive connection mechanism.

3. The vehicle wiper device according to claim 2, wherein
the mechanism speed reduction ratio of the first drive connection mechanism is a value obtained by dividing a rotation speed of the first drive source by a rotation speed of the first driving lever,
the mechanism speed reduction ratio of the second drive connection mechanism is a value obtained by dividing the rotation speed of the first drive source by a rotation speed of the second wiper arm, and
the mechanism speed reduction ratio of the first drive connection mechanism from the lower reversal position is set to be greater than the mechanism speed reduction ratio of the second drive connection mechanism from the lower reversal position.

4. The vehicle wiper device according to claim 1, wherein
the second wiper arm is pivoted by a driving force of a third drive source, and
the pivoting speed of the second wiper blade from the lower reversal position is set to be greater than the pivoting speed of the first wiper blade by setting the rotation speed of the first drive source to differ from a rotation speed of the third drive source.

5. The vehicle wiper device according to claim 4, wherein
the first drive source includes a rotation shaft directly connected to the first driving lever, and
the third drive source includes a rotation shaft directly connected to the second wiper arm.

6. The vehicle wiper device according to claim 1, wherein when the second wiper blade is located in the lower reversal position, part of the second wiper blade is located above the first wiper blade in a direction along the wiped surface.
